(19) United States
(12) Patent Application Publication
(10) Pub. No.: US 2011/0184119 A1
(43) Pub. Date: Jul. 28, 2011

(54) Bismuth-Containing Catalytic System for Polymerising Polymers

(76) Inventors: Stephan Bloess, Burscheid (DE); Thomas von Oppenkowski, Koeln (DE); Peter Gross, Leverkusen (DE)

(21) Appl. No.: 13/012,231

(22) Filed: Jan. 24, 2011

Related U.S. Application Data
(60) Provisional application No. 61/299,432, filed on Jan. 29, 2010.

(30) Foreign Application Priority Data
Jan. 26, 2010 (DE) DE 102010005868.8

(51) Int. Cl. C08L 75/16; B01J 31/04; B01J 27/135; B01J 37/02; B01J 37/03; B82Y 30/00

(52) U.S. Cl. 524/558; 502/161; 502/227; 977/773

(57) ABSTRACT

Bismuth-containing catalytic systems, formed using inorganic particles coated with at least one inorganic or organic bismuth compound that is catalytically active when polymerising polymers, characterised in that the inorganic bismuth compound is selected from the group comprising bismuth oxychloride, bismuth hydroxo-sulphate and bismuth carbonate, and in that the organic bismuth compound is selected from the group comprising bismuth acetate, bismuth benzoate, bismuth citrate, bismuth lactate and bismuth phthalate.

### RELATED APPLICATIONS

This application claims the benefit of U.S. Provisional Patent Application Ser. No. 61/299,432 filed Jan. 29, 2010, and entitled “Bismut Containing Catalytic Systems for Crosslinking Polymers” and the benefit of DE 102010005868.8 filed Jan. 26, 2010.

### TECHNICAL FIELD OF THE INVENTION

The invention relates to the bismuth-containing catalytic systems for polymerising polymers, and to a method for their manufacture.

### BACKGROUND OF THE INVENTION

Dispersions, emulsions and solutions of polymers can be used as binders in water-based coating systems. Film formation of the coating material is accomplished by polymerising (crosslinking) the polymers, in which context a catalyst is generally used. When polymerising polyisocyanates with polyols, such as in cathodic dip coating (KTL), it has to date commonly been the practice to use organic lead and tin compounds as catalysts, although they display high toxicological potential.

It is for this reason that bismuth compounds are now increasingly being used as catalysts to substitute the toxicologically active lead and tin compounds.

For example, the teaching in EP 1 135 443 B1 (DE 699 19 389 T2) describes the use of a catalytic quantity of bismuth trioxide (Bi₂O₃) for crosslinking an epoxy-amine adduct with a polyisocyanate.

In addition to bismuth trioxide, EP 0 690 106 B1 names bismuth ortho-hydroxide (Bi(OH)₃), bismuthyl hydroxide (BiO(OH)), bismuthyl nitrate ((BiO)NO₃) and bismuthyl carbonate ((BiO)₂CO₃) as suitable catalysts.

Furthermore, numerous patents describe the use of organic bismuth compounds, such as bismuth carboxylates, as catalysts in isocyanate systems (e.g. U.S. Pat. No. 4,584,362; U.S. Pat. No. 4,868,266; U.S. Pat. No. 6,124,380).

The bismuth compounds mentioned are mostly used in the form of finely dispersed powders. However, they are occasionally very hard to disperse in both water-based and solvent-based coating systems, this leading to inhomogeneous dispersion of the catalyst. As a result, a disproportionately large quantity of catalyst has to be added in order to guarantee adequate dispersion and, consequently, effective catalysis.

Moreover, most coating systems also contain pigments and, where appropriate, extenders and/or nanoparticles.

According to JP 05001236 A, titanium dioxide pigment particles surface-coated with bismuth oxide are used to accelerate the polymerisation of urethane resins. The titanium dioxide particles are coated in an alkaline slurry to which acidic Bi-containing solutions are added.

EP 0 859 017 B1 discloses water-based coating systems containing polymerisable reactants, such as isocyanates, and an inorganic carrier material with a catalyst for said reactants adsorbed thereon. The catalyst is hydrophobic, having a solubility of less than 1% by weight in water. Various organic bismuth and tin compounds are named as suitable catalysts.

### SUMMARY OF THE INVENTION

The object of the invention is to provide an alternative bismuth-containing catalyst for polymerising polymers that is readily dispersible. The object furthermore consists in providing a method for manufacturing the catalyst.

The object is solved by providing inorganic particles coated with at least one inorganic or organic bismuth compound that is catalytically active when polymerising polymers, characterised in that the inorganic bismuth compound is selected from the group comprising bismuth oxychloride, bismuth hydroxo-sulphate and bismuth carbonate, and in that the organic bismuth compound is selected from the group comprising bismuth acetate, bismuth benzoate, bismuth citrate, bismuth lactate and bismuth phthalate.

The object is furthermore solved by a method for manufacturing inorganic particles coated with at least one inorganic or organic bismuth compound that is catalytically active when polymerising polymers, characterised in that the bismuth compound is precipitated onto the particle surface.

A further solution to the object consists in the provision of a water-based coating system containing polymerisable reactants and inorganic particles that are coated with at least one inorganic or organic bismuth compound that is catalytically active when polymerising the reactants, where the inorganic bismuth compound is selected from the group comprising bismuth oxychloride, bismuth hydroxo-sulphate and bismuth carbonate, and where the organic bismuth compound is selected from the group comprising bismuth acetate, bismuth benzoate, bismuth citrate, bismuth lactate and bismuth phthalate.

A further solution to the object consists in the provision of a solvent-based coating system containing polymerisable reactants and inorganic particles that are coated with at least one inorganic or organic bismuth compound that is catalytically active when polymerising the reactants, where the inorganic bismuth compound is selected from the group comprising bismuth oxychloride, bismuth hydroxo-sulphate and bismuth carbonate, and where the organic bismuth compound is selected from the group comprising bismuth acetate, bismuth benzoate, bismuth citrate, bismuth lactate, bismuth phthalate and bismuth 2-ethyl hexanoate.

Further advantageous embodiments of the invention are described in the sub-claims.

### DESCRIPTION OF THE PREFERRED EMBODIMENTS

The subject matter of the invention is, on the one hand, an inorganic, particulate carrier material that is coated with at least one inorganic or organic bismuth compound that is catalytically active when polymerising polymers and is readily dispersible in polymer systems, particularly in water-based and solvent-based coating systems based on isocyanates, epoxides or urea derivatives, particularly melamine derivatives.

Open to consideration as the particulate carrier material are inorganic particles that can be used in coating systems, such as extenders, pigments or nanoparticles. Particularly suitable is titanium dioxide, which demonstrates very good dispersibility in coating systems.

The Inorganic bismuth compounds bismuth oxychloride, bismuth hydroxo-sulphate and bismuth carbonate, and the organic bismuth compounds bismuth acetate, bismuth benzoate, bismuth citrate, bismuth lactate, bismuth phthalate and bismuth 2-ethyl hexanoate, have proven to be suitable bismuth compounds. In a special embodiment of the invention, the particles are coated with a hydrophilic organic bismuth compound, preferably with bismuth acetate or bismuth lactate.

In the context of the invention, the term “hydrophilic bismuth compound” is taken to mean a bismuth compound displaying a hydrophilic surface following application to the particle. Hydrophilic surfaces display a contact angle of less than 90° between the surface and water. In contrast, hydrophobic surfaces display a contact angle of more than 90° between the surface and water.

The particles according to the invention are advantageously coated with 0.1 to 15% by weight, preferably 0.5 to 5% by weight, and particularly 1 to 3.5% by weight bismuth, calculated as Bi₂O₃ and referred to the total particles.

The particles according to the invention preferably display good catalytic activity both in water-based and in solvent-based coating systems. Moreover, the particles according to the invention can be incorporated into the polymer system, or one of its individual components, more homogeneously and with less dispersing effort than the bismuth compound itself. The consequence of this is that productivity can be increased owing to the greater ease of incorporation.

The subject matter of the invention is furthermore a method for manufacturing inorganic particles coated with a bismuth compound that is catalytically active when polymerising polymers. According to the invention, the coated particles are manufactured by precipitating the bismuth compound onto the particle surface. In this context, the bismuth can be precipitated in the form of an organic compound or an inorganic compound.

The organic bismuth compounds can be hydrophilic or hydrophobic. For example, bismuth acetate, bismuth lactate, bismuth citrate, bismuth benzoate, bismuth phthalate and bismuth 2-ethyl hexanoate have proven to be suitable. In a special embodiment of the invention, bismuth acetate or bismuth lactate is precipitated.

Bismuth oxychloride, bismuth hydroxo-sulphate and bismuth carbonate have proven to be suitable inorganic bismuth compounds.

The particles are preferably coated in the aqueous phase. An aqueous suspension of the particles to be coated is produced first. An aqueous solution of a bismuth compound serving as the source of bismuth is subsequently added. Any bismuth compound soluble in the aqueous phase is suitable as the bismuth source. A particularly suitable compound has proven to be bismuth trinitrate pentahydrate (Bi(NO₃)₃*5H₂O), which is soluble in 20% acetic acid or can be converted into a stabilised, water-soluble form with polyalcohols, such as sorbitol, xylitol, glycerol, etc.

In a special embodiment of the invention, acid (e.g. HNO₃ or H₂SO₄) is used, before or after addition of the bismuth source to the solution, to lower the pH value to such an extent that homogeneous mixing of the bismuth source and the particles to be treated is achieved before the actual precipitation of the organic or inorganic bismuth compound. The pH value is preferably set to 3 or less.

To precipitate organic bismuth compounds, at least one bismuth-compatible, water-soluble organic compound is subsequently added. In the context of the invention, the term “bismuth-compatible, water-soluble organic compounds” is taken to mean water-soluble organic compounds capable of making ionic or coordinate bonds with bismuth, such as carboxylic acids, alcohols, amines, thiols, ethers or their salts. The bismuth-compatible, water-soluble organic compound is added at an approximately stoichiometric ratio to bismuth. The ratio can be varied in order to increase the precipitation yield. The organic bismuth compound is subsequently precipitated by adding a lye (e.g. NaOH). The person skilled in the art is familiar with the corresponding pH values at which precipitation occurs.

To apply inorganic bismuth compounds to the particle surface, an inorganic acid is added at a stoichiometric ratio to bismuth. In this context, H₂SO₄, H₂CO₃ and HCl have proven practicable for precipitating Bi(OH)SO₄, Bi(CO₃)₃ and BiOCl, respectively. After addition of the acid, the inorganic bismuth compound is precipitated immediately or, where appropriate, by setting the pH value accordingly. The person skilled in the art is familiar with the corresponding pH values and their setting.

In a special embodiment of the invention, lowering of the pH value to pH≦3, which can take place before or after addition of the bismuth source, is performed using an inorganic acid. Depending on the required precipitated form, suitable acid ions can already be added at this point, e.g. for precipitating Bi(OH)SO₄ or BiOCl.

In a special embodiment of the invention, multiple layers of different bismuth compounds can be produced by successive addition of different bismuth-compatible, water-soluble organic compounds or different inorganic acid ions.

In a further embodiment of the invention, mixed layers can be produced by simultaneous addition of different bismuth-compatible, water-soluble organic compounds or different inorganic acid ions.

According to the invention, the quantity of inorganic or organic bismuth compounds applied to the particle surface is 0.1 to 15% by weight, preferably 0.5 to 5% by weight and particularly 1 to 3.5% by weight, calculated as Bi₂O₃ and referred to the total particles.

A special embodiment of the invention uses pigmentary titanium dioxide particles, produced by the sulphate process or the chloride process. The particles can first undergo customary inorganic surface treatment by the familiar treatment methods, e.g. with SiO₂, Al₂O₃ or similar. Bismuth coating is subsequently performed by first adding the bismuth source and then the required counterions, in the form of at least one bismuth-compatible, water-soluble organic compound or in the form of at least one inorganic acid, and inducing precipitation of the bismuth compound—by adjusting the pH value, where appropriate. The pH values set are generally in the range from 0 to 7.

Multiple layers of different bismuth compounds can be obtained by successive addition, and it is also possible to produce mixed layers by simultaneously adding different counterions.

According to the invention, the quantity of inorganic or organic bismuth compounds applied to the pigment particle surface is 0.1 to 15% by weight, preferably 0.5 to 5% by weight and particularly 1 to 3.5% by weight, calculated as Bi₂O₃ and referred to the total pigment.

The particles manufactured according to the invention preferably display good catalytic activity both in water-based and in solvent-based coating systems.

The subject matter of the invention is furthermore a water-based coating system containing polymerisable reactants, as well as inorganic particles that are coated with at least one inorganic or organic bismuth compound that is catalytically active when polymerising the reactants, where the inorganic bismuth compound is selected from the group comprising Bi oxychloride, Bi hydroxo-sulphate and Bi carbonate, and where the organic bismuth compound is selected from the group comprising Bi acetate, Bi benzoate, Bi citrate, Bi lactate and Bi phthalate.

The subject matter of the invention is furthermore a solvent-based coating system containing polymerisable reactants, as well as inorganic particles that are coated with at least one inorganic or organic bismuth compound that is catalytically active when polymerising the reactants, where the inorganic bismuth compound is selected from the group comprising Bi oxychloride, Bi hydroxo-sulphate and Bi carbonate, and where the organic bismuth compound is selected from the group comprising Bi acetate, Bi benzoate, Bi citrate, Bi lactate, Bi phthalate and Bi 2-ethyl hexanoate.

The coating systems are preferably polymer systems based on isocyanates, epoxides or urea derivatives, particularly melamine derivatives.

### EXAMPLES

The invention is explained in more detail on the basis of the examples below, although this is in no way intended to restrict the invention.

A) Production of the Bismuth-Coated TiO₂ Pigment Particles:

For the catalytic investigations, use was made of TiO₂ pigment particles manufactured by the chloride process (Examples 1 to 8 and Reference Example 1) or sulphate process (Examples 9a, b, c and 10a, b, and c, and Reference Example 2 and 3). The particles were subsequently coated with bismuth acetate, bismuth lactate, bismuth tartrate, bismuth citrate, bismuth benzoate, bismuth phthalate, bismuth 2-ethyl hexanoate or bismuth laurate, as described below.

### Example 1

An aqueous suspension of TiO₂ pigment particles (400 g/l) was set to a pH value of 3 with H₂SO₄. While stirring, 2.5% by weight of the bismuth source, sorbitol-stabilised bismuth trinitrate pentahydrate, calculated as Bi₂O₃, and acetic acid at a stoichiometric ratio of Bi:acetate=1:3, were added within 30 minutes and stirred for 15 minutes. NaOH was subsequently used for neutralisation. The TiO₂ particles were then separated out and dried.

### Example 2

Same as Example 1, except that, instead of acetic acid, lithium lactate was added at a stoichiometric ratio of Bi:lactate=1:3.

### Example 3

Same as Example 1, except that, instead of acetic acid, tartaric acid was added at a stoichiometric ratio of Bi:tartrate=2:3.

### Example 4

Same as Example 1, except that, instead of acetic acid, citric acid was added at a stoichiometric ratio of Bi:citrate=1:1.

### Example 5

Same as Example 1, except that, instead of acetic acid, benzoic acid was added at a stoichiometric ratio of Bi:benzoate=1:3.

### Example 6

Same as Example 1, except that, instead of acetic acid, phthalic acid was added at a stoichiometric ratio of Bi:phthalate=2:3.

### Example 7

Same as Example 1, except that, instead of acetic acid, 2-ethyl hexanoic acid was added at a stoichiometric ratio of Bi:2-ethyl-hexanoate=1:3.

### Example 8

Same as Example 1, except that, instead of acetic acid, lauric acid was added at a stoichiometric ratio of Bi:laurate=1:3.

### Example 9 (a, b, c)

Same as Example 1, except that 1.0% by weight (a), 3.5% by weight (b) or 5.0% by weight (c) of the bismuth source, calculated as Bi₂O₃, was added, and except that the titanium dioxide pigment had been manufactured by the sulphate process.

### Example 10 (a, b, c)

An aqueous suspension of TiO₂ pigment particles (400 g/l) manufactured by the sulphate process was set to a pH value of 3 with HCl. While stirring, 1% by weight (a), 2% by weight (b) or 3% by weight (c) of the bismuth source, sorbitol-stabilised bismuth trinitrate pentahydrate, calculated as Bi₂O₃, was added and the pH value was set to 7 by means of NaOH within 30 minutes. The TiO₂ particles were then separated out and dried.

### Reference Examples 1, 2 and 3

An aqueous suspension of TiO₂ pigment particles (400 g/l) was set to a pH value of 3 with H₂SO₄ and stirred for 25 minutes. NaOH was subsequently used for neutralisation. The TiO₂ particles were then separated out and dried.

B) Two-Pack Polyurethane System

The pigments from Examples 1 to 8 and the pigment from Reference Example 1 were investigated both in a solvent-based and in a water-based two-pack polyurethane system based on a hydroxyfunctional acrylic resin (4.5% by weight and 4.2% by weight OH content, respectively), which was crosslinked with an aliphatic isocyanate (NCO content: 16.9% by weight and 18% by weight, respectively).

Example pigments 9a, 9b and 9c and Reference Example pigment 2, as well as Example pigments 10a, 10b and 10c and Reference Example pigment 3, were incorporated into the same two-pack polyurethane systems, but the acrylic resin and the isocyanate were in each case from different batches. The absolute values of the test results for Example 1 and Examples 9a, 9b and 9c, as well as for Reference Example 1, Reference Example 2 and Reference Example 3, are therefore not comparable.

The TiO₂ concentration was 28% by weight in each case. The pigments were dispersed in a Skandex mixer or a bead mill in each case.

The curing of the binder was investigated on the basis of the gel point and the change in viscosity.

### Test Results

### 1. Determination of the Gel Point

The gel point characterises the state of a system in which the storage modulus (G′) and the loss modulus (G″) are equal. In other words, the gel point is the point at which the plastic component and the elastic component in a system are equal.

However, determination of the gel point is only suitable for characterising the catalytic activity of the particles according to the invention in solvent-based two-pack polyurethane systems because, in water-based systems, CO₂ is produced during crosslinking due to the reaction between the polyisocyanate and water, this having a negative impact on the oscillation measurement used to determined the gel point.

A rotational viscometer from Messrs. Physica (MCR 300) was used for determining the gel point. The samples were conditioned by heating to 80° C. The measurements were carried out using a frequency of 1 Hz and a constant deformation of Y=0.4%.
The gel point is stated in [sec]. A low value indicates greater activity of the catalyst.

### 2. Change in Viscosity

Since determination of the gel point is not suitable for characterising the catalytic activity of the products in water-based two-pack polyurethane systems, viscosity profiles were measured for the water-based two-pack polyurethane systems, immediately after addition of the isocyanate (t₀ₘᵢₙ, starting viscosity) and 180 minutes after addition of the isocyanate (t₁₈₀ min, reaction time 180 minutes).

The viscometer from Messrs. Physica (MCR 300) was used for the measurements. The following measuring profile served as the basis:
Measuring system: CP 50-1 (cone/plate with a diameter of 50 mm-1 mm)
Maximum shear rate: 6,000.01 l/s
Maximum shear stress: 4,584 Pa

### Temperature: 22° C.

The molar mass increases as a result of the crosslinking reaction, meaning that a rise in viscosity can be detected after a reaction time of 3 hours. The catalytic activity was assessed on the basis of the change in viscosity (t₁₈₀ₘᵢₙ-t₀ₘᵢₙ) at a shear rate of 105 Hz, since it can be assumed that gel particles are destroyed at this shear rate, whereas a polymeric network is preserved.

The change in viscosity is stated in [mPas]. A high value indicates greater activity of the catalyst.

### Test Results

TABLE 1

| | Gel point | Change in viscosity |
|---|---|---|
| | [sec] | [mPas] |
| Example 1 (Bi acetate) | 676 | 46 |
| Example 2 (Bi lactate) | 625 | 37 |
| Example 3 (Bi tartrate) | 793 | 72 |
| Example 4 (Bi citrate) | 709 | 55 |
| Example 5 (Bi benzoate) | 617 | 54 |
| Example 6 (Bi phthalate) | 667 | 70 |
| Example 7 (Bi 2-ethyl hexanoate) | 356 | 90 |
| Example 8 (Bi laurate) | n.d. | 22 |
| Reference Example 1 | 1410 | 15 |

TABLE 2

| | Gel point | Change in viscosity |
|---|---|---|
| | [sec] | [mPas] |
| Example 9a (Bi acetate) | 802 | 112 |
| Example 9b (Bi acetate) | 356 | 365 |
| Example 9c (Bi acetate) | n.d. | 1722 |
| Reference Example 2 | 1140 | 75 |

TABLE 3

| | Gel point | Change in viscosity |
|---|---|---|
| | [sec] | [mPas] |
| Example 10a (Bi oxychloride) | 713 | 2300 |
| Example 10b (Bi oxychloride) | 558 | 2400 |
| Example 10c (Bi oxychloride) | 549 | 2500 |
| Reference Example 3 | 894 | 790 |

Table 1 shows that, surprisingly, only the particles coated with Bi acetate, Bi lactate, Bi benzoate, Bi citrate, Bi phthalate and Bi 2-ethyl hexanoate demonstrate good catalytic activity in both the solvent-based coating system (gel time) and the water-based coating system (change in viscosity), whereas the particles coated with Bi laurate and Bi tartrate each only demonstrate good catalytic activity in one of the two coating systems. In the case of Example 8 (coating with Bi laurate), the gel point could not be determined in the solvent-based coating system, because the catalyst increased the crosslinking speed to such an extent that the system already cured during the heating phase.

Table 2 shows the influence of the quantity of bismuth compound (Example 9: Bi acetate) on the particle surface on the gel time in a solvent-based coating system, and on the change in viscosity in a water-based coating system.

The higher the Bi content on the carrier material, the shorter the gel time (solvent-based coating system) or the greater the change in viscosity (water-based coating system).

Table 3 shows the catalytic activity of the inorganic bismuth compound (Example 10: Bi oxychloride) and the influence of the quantity of bismuth compound on the gel time in a solvent-based coating system, and on the change in viscosity in a water-based coating system.

All the results show that the polymerisation of water-based and solvent-based polymer/isocyanate systems is catalysed by the pigments according to the invention.

1. A catalytically active compound comprising:
inorganic particles coated with at least one inorganic or organic bismuth compound that is catalytically active when polymerising polymers;
wherein the inorganic bismuth compound is selected from the group consisting of bismuth oxychloride, bismuth hydroxo-sulphate, bismuth carbonate, and combinations thereof; and
wherein the organic bismuth compound is selected from the group consisting of bismuth acetate, bismuth benzoate, bismuth citrate, bismuth lactate and bismuth phthalate, and combinations thereof.

2. The compound of claim 1, wherein the inorganic particles are extender particles, pigment particles or nanoparticles.

3. The compound of claim 1, wherein the coating of the at least one inorganic or organic bismuth compound contains from about 0.1 to about 15 weight percent bismuth, calculated as Bi₂O₃ by weight of the total particles.

4. The compound of claim 1, wherein the coating of the at least one inorganic or organic bismuth compound contains from about 1 to about 3.5 weight percent bismuth, calculated as Bi₂O₃ by weight of the total particles.

5. The compound of claim 1, wherein the inorganic particles are titanium dioxide.

6. The compound of claim 5, wherein the coating of the at least one inorganic or organic bismuth compound contains from about 0.1 to about 15 weight percent bismuth, calculated as Bi₂O₃ by weight of the total particles.

7. The compound of claim 5, wherein the coating of the at least one inorganic or organic bismuth compound contains from about 0.5 to about 5 weight percent bismuth, calculated as Bi₂O₃ by weight of the total particles.

8. The compound of claim 5, wherein the coating of the at least one inorganic or organic bismuth compound contains from about 1 to about 3.5 weight percent bismuth, calculated as Bi₂O₃ by weight of the total particles.

9. The compound of claim 1 wherein the inorganic particles are titanium dioxide and the bismuth compound is selected from the group consisting of bismuth acetate and bismuth lactate.

10. A method for manufacturing a catalytically active compound, the steps comprising:
coating inorganic particles with at least one inorganic or organic bismuth compound that is catalytically active when polymerising polymers;
wherein the inorganic bismuth compound is selected from the group consisting of bismuth oxychloride, bismuth hydroxo-sulphate, bismuth carbonate, and combinations thereof;
wherein the organic bismuth compound is selected from the group consisting of bismuth acetate, bismuth benzoate, bismuth citrate, bismuth lactate, bismuth phthalate, bismuth 2-ethyl hexanoate and combinations thereof.

11. The method of claim 10 wherein the bismuth compound is precipitated onto the particle surface.

12. The method of claim 11 wherein the bismuth compound is precipitated onto the inorganic particles in a quantity of from about 0.1 to about 15 weight percent, calculated as Bi₂O₃ by weight of the total particles.

13. The method of claim 11 wherein the bismuth compound is precipitated onto the inorganic particles in a quantity of from about 0.5 to about 5 weight percent, calculated as Bi₂O₃ by weight of the total particles.

14. The method of claim 11 wherein the bismuth compound is precipitated onto the inorganic particles in a quantity of from about 1 to about 3.5 weight percent, calculated as Bi₂O₃ by weight of the total particles.

15. The method of claim 10 further comprising:
a) providing an aqueous suspension of the inorganic particles;
b) adding an aqueous solution of a bismuth source to the aqueous suspension;
c) adding at least one inorganic acid to the aqueous suspension at a stoichiometric ratio to bismuth,
d) precipitating an inorganic bismuth compound onto a surface of the inorganic particles.

16. The method of claim 15 wherein bismuth trinitrate pentahydrate (Bi(NO₃)₃*5H₂O) is used as the bismuth source.

17. The method of claim 15 wherein the bismuth compound used as the bismuth source is stabilized.

18. The method of claim 17 wherein the bismuth compound used as the bismuth source is stabilized with a polyalcohol.

19. The method of claim 15, wherein the inorganic particles are titanium dioxide.

20. The method of claim 15, wherein;
bismuth trinitrate pentahydrate (Bi(NO₃)₃*5H₂O) is used as the bismuth source;
the bismuth compound used as the bismuth source is stabilized with a polyalcohol;
the inorganic particles are titanium dioxide; and
the bismuth compound is precipitated onto the inorganic particles in a quantity of from about 0.1 to about 15 weight percent, calculated as Bi₂O₃ by weight of the total particles.

21. The method of claim 20 wherein the bismuth compound is precipitated onto the inorganic particles in a quantity of from about 0.5 to about 5 weight percent, calculated as Bi₂O₃ by weight of the total particles.

22. The method of claim 20 wherein the bismuth compound is precipitated onto the inorganic particles in a quantity of from about 1 to about 3.5 weight percent, calculated as Bi₂O₃ by weight of the total particles.

23. The method of claim 10 further comprising:
a) providing an aqueous suspension of the inorganic particles;
b) adding an aqueous solution of a bismuth source to the aqueous suspension;
c) adding at least one bismuth-compatible, water-soluble organic compound to the aqueous suspension at a stoichiometric ratio to bismuth, and
d) precipitating an organic bismuth compound onto a surface of the inorganic particles.

24. The method of claim 23 wherein bismuth trinitrate pentahydrate (Bi(NO₃)₃*5H₂O) is used as the bismuth source.

25. The method of claim 23 wherein the bismuth compound used as the bismuth source is stabilized.

26. The method of claim 25 wherein the bismuth compound used as the bismuth source is stabilized with a polyalcohol.

27. The method of claim 23, wherein the inorganic particles are titanium dioxide.

28. The method of claim 23, wherein;
bismuth trinitrate pentahydrate (Bi(NO₃)₃*5H₂O) is used as the bismuth source;
the bismuth compound used as the bismuth source is stabilized with a polyalcohol;
the inorganic particles are titanium dioxide; and
the bismuth compound is precipitated onto the inorganic particles in a quantity of from about 0.1 to about 15 weight percent, calculated as Bi₂O₃ by weight of the total particles.

29. The method of claim 28 wherein the bismuth compound is precipitated onto the inorganic particles in a quantity of from about 0.5 to about 5 weight percent, calculated as Bi₂O₃ by weight of the total particles.

30. The method of claim 28 wherein the bismuth compound is precipitated onto the inorganic particles in a quantity of from about 1 to about 3.5 weight percent, calculated as Bi₂O₃ by weight of the total particles.

31. The method of claim 11 further comprising the step of using the coated inorganic particles as a catalyst for polymerising water-based or solvent-based coating systems.

32. The method of claim 11 wherein the inorganic particles are titanium dioxide and the bismuth compound is selected from the group consisting of bismuth acetate and bismuth lactate.

33. A coating system comprising:
an aqueous carrier;
polymerisable reactants;
inorganic particles coated with at least one inorganic or organic bismuth compound that is catalytically active when polymerising the reactants;
wherein the inorganic bismuth compound is selected from the group consisting of bismuth oxychloride, bismuth hydroxo-sulphate, bismuth carbonate, and combinations thereof; and
wherein the organic bismuth compound is selected from the group comprising bismuth acetate, bismuth benzoate, bismuth citrate, bismuth lactate, bismuth phthalate and combinations thereof.

34. A coating system comprising:
a carrier comprising a solvent;
polymerisable reactants;
inorganic particles coated with at least one inorganic or organic bismuth compound that is catalytically active when polymerising the reactants;
wherein the inorganic bismuth compound is selected from the group consisting of bismuth oxychloride, bismuth hydroxo-sulphate, bismuth carbonate, and combinations thereof; and
wherein the organic bismuth compound is selected from the group comprising bismuth acetate, bismuth benzoate, bismuth citrate, bismuth lactate, bismuth phthalate, bismuth 2-ethyl hexanoate, and combinations thereof.
